(19) United States
(12) Patent Application Publication
(10) Pub. No.: US 2026/0119476 A1
(43) Pub. Date: Apr. 30, 2026

(54) GRAPH-BASED DETECTION OF CONFLICTING ALIASES IN LANGUAGE MODEL-BASED TEXT TO DATABASE QUERY CONVERSION SYSTEMS

(71) Applicant: Palo Alto Networks, Inc., Santa Clara, CA (US)

(72) Inventors: Lei Xu, Sunnyvale, CA (US); Mengying Hu, Santa Clara, CA (US); Yu Fu, Sunnyvale, CA (US); Qi Zhang, Saratoga, CA (US)

(21) Appl. No.: 18/932,084

(22) Filed: Oct. 30, 2024

(51) Int. Cl. G06F 16/23; G06F 16/21; G06F 16/2455

(52) U.S. Cl. CPC G06F 16/2365; G06F 16/211; G06F 16/2455

(57) ABSTRACT

Conflicting aliases in database queries are identified with a graph-based approach. A conflict detector builds a base graph comprising nodes representing the database's tables and fields and edges representing relationships between the tables and fields. The detector iterates over one or more database queries and augments the base graph with nodes representing aliases of tables/fields identified in each database query. The detector inserts an edge between each node corresponding to an alias and the node of the base graph corresponding to the aliased table or field. For table aliases, the detector inserts an edge between the table alias node and each node of the base graph corresponding to a field of the table that is indicated in the database query. The detector evaluates the augmented graph for the presence of cycles that indicate that the database query(ies) represented in nodes therein include conflicting aliases.

### BACKGROUND

The disclosure generally relates to data processing (e.g., CPC subclass G06F) and to information retrieval and database structures therefor (e.g., CPC subclass G06F 16/00).

The Stanford Institute for Human-Centered Artificial Intelligence created an interdisciplinary initiative named the Center for Research on Foundation Models. They coined the term “foundation models” to refer to machine learning models “trained on broad data at scale such that they can be adapted to a wide range of downstream tasks.” Some models considered foundation models include BERT, GPT-4, Codex, and LLaMA. Foundation models are based on artificial neural networks including generative adversarial networks (GANs), transformers, and variational encoders.

Multiple applications of foundation models in the field of natural language processing, particularly in the case of language models such as large language models (LLMs), have been realized. One such application is the use of language models for generating database query language representations of queries comprising natural language indicated in prompts, such as for generating Structured Query Language (SQL) queries representing natural language text. Solutions for generating SQL queries representing queries comprising natural language are sometimes referred to as “text-to-SQL conversion” solutions. Language models used for text-to-SQL conversion or conversion of natural language text to other database query languages can be pre-trained models adapted for this task with various techniques, such as prompt tuning, fine-tuning, or with one-or few-shot prompting using prompts engineered for the task of generating database queries from natural language text.

### BRIEF DESCRIPTION OF THE DRAWINGS

Embodiments of the disclosure may be better understood by referencing the accompanying drawings.

FIG. 1 is a conceptual diagram of detecting conflicting aliases in a training dataset used for training/teaching a language model to generate database queries representing natural language text.

FIG. 2 is a conceptual diagram of detecting conflicting aliases in a database query generated by a language model.

FIG. 3 is a flowchart of example operations for building a graph representing a schema of a target database.

FIG. 4 is a flowchart of example operations for updating a graph representing a database schema based on a dataset comprising example database queries.

FIG. 5 is a flowchart for detecting conflicts in a dataset for adapting a foundation model for text-to-database query conversion.

FIG. 6 is a flowchart of example operations for detecting conflicts in a database query generated by a foundation model from natural language text.

FIG. 7 depicts an example computer system with a database query conflict detector.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### Terminology

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

### Overview

Technologies that use language models to generate database query language representations of natural language text that are executable against a target database can be subject to various threats. One such threat involves providing the language model with correct but conflicting database queries included in training data examples, which may be introduced into the training data by an adversary or due to unintentional errors by developers. Conflicting database queries are generally those that include different aliases for the same database table or field name. While each individual database query that comprises a conflicting alias is correct and executable against the target database, the language model may learn from the conflicting aliases and generate a database query that uses both aliases to refer to the same table or field and thus is not executable.

Conflicting aliases in database queries in a training dataset used for such language model-based natural language-to-database query language conversion technologies, such as those for text-to-SQL conversion, can be identified with a graph-based approach disclosed herein. A conflict detector builds a base graph representing a schema of a target database (e.g., a production database), which includes table names and fields of each table. The conflict detector builds the base graph such that it comprises nodes representing each table and field of the target database and edges representing relationships between tables and fields (i.e., relationships indicating fields of each table represented with corresponding nodes). The conflict detector then iterates over database queries included in a training dataset (“example database queries”) and augments the base graph with nodes corresponding to aliases for tables and/or fields identified in the example database queries. The conflict detector connects these nodes to the corresponding nodes of the base graph representing the tables and/or fields being aliased with edges to indicate relationships between aliases and the tables/fields to which they refer. For each database query comprising an alias of a table, the conflict detector also connects the node representing the table alias to each node corresponding to a field of the table referenced in the database query. Once the base graph has been augmented based on the example database queries, the conflict detector evaluates the augmented graph to determine if any cycles comprising nodes representing different, unrelated aliases for the same table or field exist. A cycle comprising nodes representing aliases that do not have an edge therebetween is indicative that two different aliases representing the same field or table have been defined without a corresponding aliasing relationship defined therebetween. If the conflict detector identifies such a cycle in the graph, the conflict detector determines that the example database queries represented in nodes included in the cycle include a conflict. The example database queries determined to include the conflict can thus be corrected before they are provided to the language model. Further, the graph-based approach to alias conflict detection provides for rapid detection of conflicts based on execution of graph analyses and lookups.

For further mitigation of errors resulting from the language model learning from inconsistent database queries, the detector can also be deployed in a production environment to verify that database queries generated by the language model for consumption by end users do not include conflicting aliases. The detector evaluates each database query generated by the language model using the graph built from the target database through creation of nodes and edges based on identifying any aliases in the database query to determine if the database query includes a conflict in aliases included therein. If a database query is determined to include a conflict, the detector notifies the user that the database query being provided in response to their prompt may not be properly executable.

### Example Illustrations

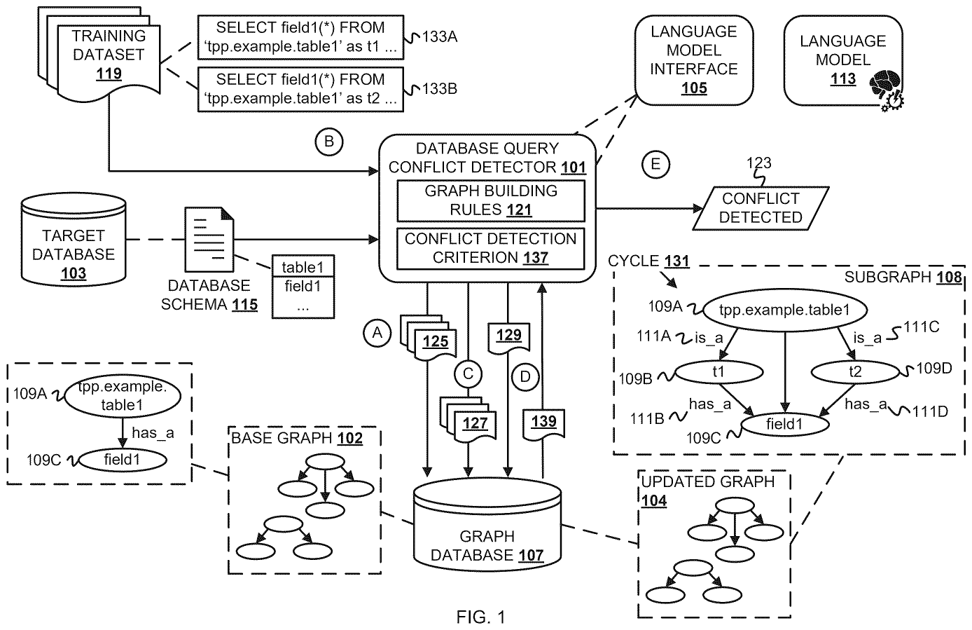

FIG. 1 is a conceptual diagram of detecting conflicting aliases in a training dataset used for training/teaching a language model to generate database queries representing natural language text. A database query conflict detector (“conflict detector”) 101 executes as part of a language model interface 105. The language model interface 105 submits prompts to and receives responses from a language model 113, such as an LLM, for generating database queries corresponding to natural language text indicated in prompts. FIG. 1 also depicts a target database 103. The target database 103 may be a production database of an organization, for instance. The target database 103 has a plurality of tables and columns indicated in a schema 115 thereof. The schema 115 may be stored in a file, data structure, etc. that indicates the tables and columns of the target database 103.

FIG. 1 is annotated with a series of letters A-E. Each letter represents a stage of one or more operations. Although these stages are ordered for this example, the stages illustrate one example to aid in understanding this disclosure and should not be used to limit the claims. Subject matter falling within the scope of the claims can vary from what is illustrated.

At stage A, the conflict detector 101 builds a base graph 102 representing the schema 115 of the target database 103. The conflict detector 101 processes the schema 115 to identify tables and fields (e.g., column names) of the target database 103 and creates the base graph 102 representing the tables, fields, and relationships between each table and its respective fields. The conflict detector 101 builds the base graph 102 in a graph database 107 in this example. The graph database 107 may be stored on an external server, which may be a cloud-based or virtual server accessible to the conflict detector 101. For each table identified in the schema 115, the conflict detector 101 inserts a node in the graph database 107 representing the table. The conflict detector 101 associates an indication of each table name with the respective node inserted in the graph database 107 (e.g., by storing the table name as a node property, in a key-value pair of the node, as node metadata, etc.). For each of the tables identified in the schema 115, the conflict detector 101 inserts nodes in the graph database 107 representing each field of the table and, for each node and corresponding field, associates an indication of the field name with the node. For each field of the table, the conflict detector 101 also inserts an edge connecting the node representing the table to the node representing the field. The edge can be labeled, assigned a property, etc. indicating a relationship type specifying that the source of the edge is a table having a field represented by the destination of the edge (e.g., “has_value”).

As an illustrative example, FIG. 1 depicts the schema 115 as comprising a table named “table1” that comprises at least a first field named “field1.” The conflict detector 101 inserts into the graph database 107 a first node representing the table “table1,” a second node representing the field “field1,” and an edge between the first and second nodes having a property, label, etc. indicating that “field1” is a field of the table “table1.” This is represented in the base graph 102 with a node 109A representing “tpp.example.table1” and a node 109C connected thereto that represents the field “field1”. Insertion of nodes and edges into the graph database 107 is performed via one or more graph database queries 125 submitted to the graph database 107 (e.g., via an application programming interface (API) or query interface of the graph database 107).

At stage B, the conflict detector 101 obtains a training dataset 119 comprising a plurality of training examples, where each training example includes natural language text and a corresponding database query. The training dataset 119 can be stored in a file and provided to the conflict detector 101 from user input, retrieved by the conflict detector 101 from a storage location (e.g., from a designated repository), etc. The training dataset 119 comprises two example database queries in this example, with their corresponding natural language text omitted from FIG. 1 for simplicity and clarity. A database query 133A comprises a SQL SELECT statement to select values from a field “field1” of a table of the target database 103 “tpp.example.table1”, with this table given an alias “t1”. A database query 133B comprises a SQL SELECT statement to select values from the field “field1” of the table “tpp.example.table1”, with this table given an alias “t2”.

At stage C, the conflict detector 101 updates the base graph 102 based on aliases of tables and/or field names of the target database 103 identified in the training dataset 119. The conflict detector 101 iterates through database queries included in the training dataset 119 and, for each database query, determines if the database query includes an alias. The determination of whether a database query includes an alias can be based on syntax of the database query, such as whether the database query includes an “as” keyword (e.g., identified based on parsing, searching, etc. the database query). For each alias identified in the database queries of the training dataset 119, the conflict detector 101 updates the base graph 102 based on graph building rules 121. The graph building rules 121 indicate one or more criteria for adding nodes and edges to the base graph 102. For instance, the graph building rules 121 can indicate a rule for adding a node representing (e.g., via a property, label, etc.) an alias identified in a database query and a rule for adding one or more edges to other nodes. To illustrate, the graph building rules 121 may specify that a node representing an alias for a table or field should be connected to the node of a base graph representing that table or field via a directed edge originating from the base graph node and may further specify a type of the edge to indicate as a label, edge property, etc. The graph building rules 121 may further specify that if an alias refers to a table in a database query and one or more fields of that table (with or without aliases) are accessed via the alias in the database query, an edge should be inserted that connects the table alias node to the field's corresponding node in the graph.

The conflict detector 101 updates the base graph 102 with the nodes via commands 127 submitted to the graph database 107 (e.g., via an API of the graph database 107). As the conflict detector 101 adds nodes and edges to the base graph 102, the conflict detector 101 may associate with each new node an indication of the corresponding training data example for which the alias represented by the node was identified, such as by adding node metadata comprising an identifier that uniquely identifies a corresponding one of the training data examples in the training dataset 119. Identities of each training data example may be included with the training data examples in the training dataset 119. To illustrate, in this example, the conflict detector 101 inserts a node in the graph database 107 representing the alias “tl” based on identifying this alias in the database query 133A, an edge between the node 109A representing the table “tpp.example.table1” and the node representing the alias “t1” indicating that the alias has been assigned to this table. The conflict detector 101 also inserts a node in the graph database 107 representing the alias “t2” based on identifying this alias in the database query 133B and inserts an edge between the node 109A representing the table “tpp.example.table1” and the node representing the alias “t2”. Updating the base graph 102 results in an updated graph 104 being maintained in the graph database 107, where the updated graph 104 comprises the plurality of nodes and edges added to the base graph 102.

As an illustrative example, FIG. 1 depicts a subgraph 108 of the updated graph 104 stored in the graph database 107 that corresponds to the table of the target database 103 named “tpp.example.table1”. The subgraph 108 comprises the node 109A representing this table. The node 109A is connected to a node 109B representing the alias “t1” with an edge 111A labeled “is_a”, and the node 109B is connected to the node 109C representing the field “field1” with an edge 111B labeled “has_a”. The conflict detector 101 added this series of nodes and edges in the updated graph 104 based on the database query 133A. The node 109A is also connected to a node 109D representing the alias “t2” with an edge 111C labeled “is_a”, and the node 109D is connected to the node 109C with an edge 111D labeled “has_a”.

At stage D, the conflict detector 101 evaluates the updated graph 104 based on a conflict detection criteria 137 to validate the example database queries included in the training dataset 119. Validation of the database queries includes determining if the training dataset 119 comprises example database queries with conflicting aliases. The conflict detection criteria 137 indicates at least a first criterion for detecting conflicts in aliases. Generally, the conflict detection criteria 137 will comprise a criterion for detecting an alias conflict if a graph comprises a cycle, which may be undirected (e.g., irrespective of the direction of edges that connect nodes in the cycle), in which two or more nodes represent aliases of tables that share a field(s) but the nodes representing the table aliases do not have an edge therebetween indicating an alias relationship exists. A cycle in the graph of this nature indicates that the same table has been assigned different aliases and there is thus a conflict in aliases. The conflict detector 101 submits at least a first query 129 to the graph database 107 for detection of the presence of a cycle in the updated graph 104 that satisfies the conflict detection criteria 137. The query 129 can specify one or more graph algorithms or analyses that can be used for cycle detection. For instance, the conflict detector 101 can submit the query 129 to perform depth-first search (DFS) or union-find for the updated graph 104 and determine whether the updated graph 104 comprises a cycle with two or more non-connected alias nodes based on a result of the DFS or union-find performed for the updated graph 104. The graph maintained in the graph database 107 can be treated as an undirected graph for the purpose of analysis for cycle detection.

Because the table represented by the node 109A has been given two different aliases, and these aliases have respective nodes included in the subgraph 108 (i.e., the nodes 109B, 109D) that are not connected with an edge indicating an alias relationship this subgraph 108 comprises a cycle 131 comprising the nodes 109A-D that satisfies the conflict detection criteria 137. The conflict detector 101 obtains a response 139 to the query 129 indicating that the subgraph 108 comprises the cycle 131 as a result of searching the graph database 107 for a cycle (e.g., via DFS or union-find), determines that the nodes of the cycle 131 representing aliases of the table “tpp.example.table1” are not connected despite referring to the same table, and the conflict detection criteria 137 is thus satisfied. For instance, the conflict detector 101 can evaluate the response 139 based on the conflict detection criteria 137 to determine if any cycles were detected and, if so, queries the graph database 107 to determine if any cycle comprising nodes representing aliases of a same table comprises non-connected nodes representing table aliases as is the case for the nodes 109B, 109D.

At stage E, the conflict detector 101 indicates that a conflict in aliases exists in the training dataset 119. The conflict detector 101 generates an indication 123 (e.g., a notification, alert, report, etc.) that the training dataset 119 comprises conflicting aliases. The indication 123 can comprise identifiers of the database queries affected by the conflict as determined based on the identifiers of training data examples associated with the nodes within the cycle. In this example, the indication 123 would identify the training data examples corresponding to the database queries 133A-B. The conflict in aliases can thus be resolved before the training dataset 119 is provided as input to the language model 113 (e.g., for fine-tuning, prompt tuning, in engineered prompts for one-shot or few-shot prompting, etc.).

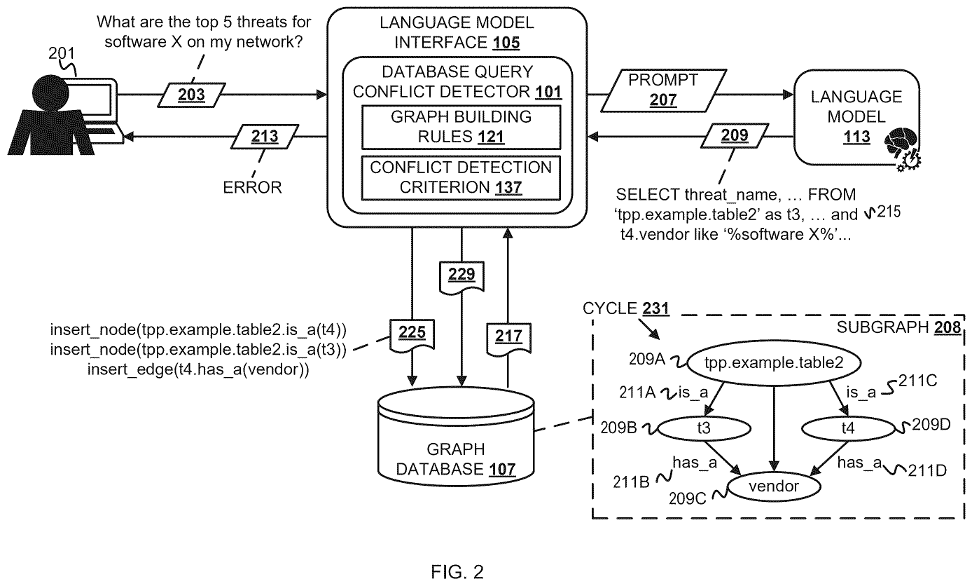

FIG. 2 is a conceptual diagram of detecting conflicting aliases in a database query generated by a language model. FIG. 2 depicts the conflict detector 101 incorporated as part of the language model interface 105 that communicates with (e.g., submits prompts to and receives responses from) the language model 113. A client 201 sends queries received from user input to the language model interface 105. The language model interface 105 can execute as an external (e.g., cloud-based) service with which the client 201 communicates or may execute locally at the client 201.

FIG. 2 also depicts the graph database 107 of FIG. 1. The graph database 107 at least stores the base graph 102 representing the target database 103 of FIG. 1. In implementations, nodes and edges corresponding to non-conflicting database queries included in training data examples may be maintained in the graph database 107 when the conflict detector 101 is deployed. In other words, nodes and edges corresponding to database queries with conflicting aliases in training data examples should be removed from the graph database 107 before deployment operations of the conflict detector 101 commence. Updating the graph database 107 based on aliases identified a database query (e.g., a SQL query) and querying the graph database 107 for cycle detection as described in FIG. 2 occur as described in reference to FIG. 1, and redundant details are not repeated for brevity.

The client 201 submits a user query 203 to the language model interface 105. The user query 203 comprises example natural language text of, “What are the top 5 threats for software X on my network?” The language model interface 105 constructs a prompt 207 comprising the natural language text identified from the user query 203 and a task instruction to generate a SQL query corresponding to the natural language text that is executable against the target database 103 (not reproduced in FIG. 2). The prompt 207 can indicate additional information to guide the language model 113 in constructing the prompt, such as example pairs of natural language text and corresponding SQL queries, the schema of the target database 103, etc. The language model interface 105 submits the prompt 207 to the language model 113 and obtains a response 209 comprising a SQL query 215, depicted in this example as comprising an example portion of a SELECT statement as “SELECT threat_name, . . . FROM ‘tpp.example.table2’ as t3, . . . and t4.vendor like ‘%software X%’”.

The conflict detector 101 processes the SQL query 215 identified from the response 209 and updates the graph database 107 based on the aliases included in the SQL query 215 based on the graph building rules 121. The conflict detector 101 submits a query 225 to the graph database 107 to insert a node representing the table “tpp.example.table2” with an edge labeled “is_a” connected to another node representing the alias “t4” given to the table in the SQL query 215. The query 225 also comprises a command to insert a node representing the “tpp.example.table2” with an edge labeled “is_a” connected to another node representing the alias “t3” given to the table in the SQL query 215. The query 225 also comprises a command to insert an edge labeled “has_a” between the node “t4” and another node representing the field “vendor”.

To illustrate, FIG. 2 depicts a subgraph 208 of the graph database 107 as a result of submitting the query 225 to update the graph stored therein. The subgraph comprises a node 209A representing the table “tpp.example.table2” that is connected to a node 209B representing the alias “t3” with an edge 211A labelled “is_a” and a node 209D representing the alias “t4” with an edge 211C labelled “is_a”. The node 209B is connected to a node 209C representing the “vendor” field with an edge 211B labelled “has_a”. The node 209D is also connected to the node 209C with an edge 211D labelled “has_a”.

The conflict detector 101 determines if the graph maintained in the graph database 107 as a result of the updates made via the query 225 comprises a cycle that is indicative of conflicting aliases. The conflict detector 101 submits a query 229 to the graph database 107 indicating a graph algorithm(s) and/or analysis(es) to perform for cycle detection and obtains a response 217 indicating that the graph comprises a cycle 231 that includes the nodes 209A-D, where the nodes representing the aliases “t3” and “t4” are not connected with an edge. The conflict detector 101 thus determines that the conflict detection criteria 137 is satisfied. Rather than executing the SQL query 215 against the target database 103, since this will result in an error, the language model interface 105 communicates a response 213 to the client 201 indicating an error occurred that resulted in the user query 203 not being fulfilled. The language model interface 105 can also generate a notification or alert and transmit the notification/alert to an entity (e.g., a cybersecurity provider) that manages the target database 103 indicating that the language model 113 is generating database queries with conflicting aliases, and there may thus be a conflict in the database query examples that have been provided to the language model 113. Corrective action can then be taken to address any conflicting aliases and/or the language model interface 105 can re-prompt the language model 113 to attempt to obtain a correct, executable database query.

FIGS. 1-2 depict examples in which the conflict detector 101 detects conflicting aliases of tables of a target database. Implementations can also detect conflicting aliases of fields of a target database. Different conflict detection criteria can be applicable to detecting conflicting aliases of fields and tables. To illustrate, consider an example training dataset that includes the following example database queries for the target database 103:

SELECT*FROM ‘tpp.example.table1’ AS t1, UNNEST(t1.signature_coverage) AS coverage WHERE “19806” IN coverage
SELECT*FROM ‘tpp.example.table1’ AS t1, UNNEST(t1.signature_coverage) AS signatures WHERE “19806” IN signatures

The conflict detector 101 will add to the graph database 107 respective nodes representing the aliases “coverage” and “signatures” and connect these nodes to the base graph node representing the field “signature_coverage” of the table “tpp.example.table1”. However, these example database queries that include both “coverage” and “signatures” as aliases for the same item may result in the following database query being output by a foundation model that learned from the conflicting field aliases in response to a prompt including a user query requesting information about the signature “19806”:SELECT* FROM ‘tpp.example.table1’ AS t1, UNNEST(t1.signature_coverage) AS coverage WHERE “19806” IN signatures

This example database query will result in an execution error due to the conflict in aliases “coverage” and “signatures”. Since these are both aliases of the same field (i.e., signature_coverage in tpp.example.table1), the conflict detector 101 can add an edge connecting the respective nodes, which will result in a cycle in the updated graph. As a result, the conflict detector 101 will update a cycle formed by multiple nodes corresponding to a field name (i.e., a cycle between the base graph node for “signature_coverage” and the nodes representing its aliases “coverage” and “signatures”). The conflict detection criteria 137 may also indicate a criterion for conflict detection in the event that a cycle is formed between nodes representing a same field name with multiple conflicting aliases. For this case, the conflict detector 101 determines that the cycle satisfies this criterion and identifies the conflict between the aliases of “signature_coverage”. The conflict can be indicated for resolution as similarly described above.

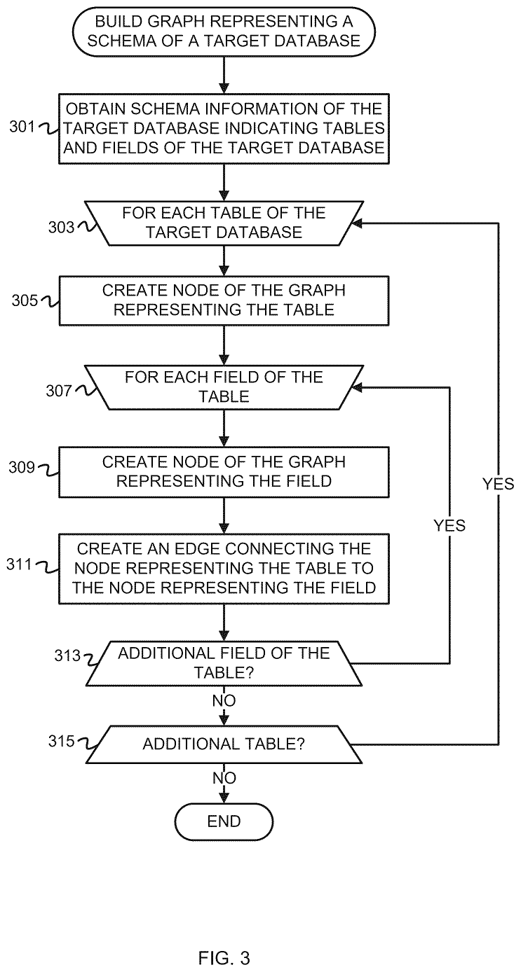

FIGS. 3-6 are flowcharts of example operations. The example operations are described with reference to a database query conflict detector (hereinafter simply “the conflict detector”) for consistency with the earlier figures and/or ease of understanding. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary.

FIG. 3 is a flowchart of example operations for building a graph representing a schema of a target database. The target database is a database against which database queries generated by a foundation model (e.g., an LLM) will be executed to fulfill queries comprising natural language text. For instance, the target database may be a production database managed by a cybersecurity provider.

At block 301, the conflict detector obtains schema information of the target database indicating tables and fields of the target database. The schema information may be stored in a file, data structure(s), etc. that the conflict detector is provided or that the conflict detector obtains from a storage location.

At block 303, the conflict detector iterates through tables of the target database. The conflict detector identifies each table indicated in the target database's schema (e.g., as a result of parsing the schema information).

At block 305, the conflict detector creates a node of the graph representing the table. The conflict detector creates a node of the graph that identifies the table, such as with a property value, a node label, node metadata, etc. The graph may be maintained in a graph database to which the conflict detector submits queries to create nodes.

At block 307, the conflict detector iterates over each field of the table. The conflict detector identifies each field indicated in the target database's schema in association with the table.

At block 309, the conflict detector creates a node of the graph representing the field. The conflict detector creates a node of the graph that identifies the field, such as with a property value, a node label, node metadata, etc. For instance, the conflict detector can submit a query to the graph database in which the graph is maintained with a command for creating a new node of the graph.

At block 311, the conflict detector creates an edge that connects the node representing the table to the node representing the field. For instance, the conflict detector can submit a query to the graph database in which the graph is maintained with a command for creating a new edge of the graph that indicates the table and field name represented by the nodes to be connected. The edge may be a directed edge that originates at the node representing the table. The conflict detector may also associate a property, label, metadata, etc. with the edge indicating that the relationship between connected nodes is a table-field relationship.

At block 313, the conflict detector determines if there is an additional field of the table. If so, operations continue at block 307. Otherwise, if each field of the table is represented with a node of the graph, operations continue at block 315.

At block 315, the conflict detector determines if there is an additional table indicated in the target database's schema. If so, operations continue at block 303. Otherwise, operations as complete. The resulting graph may be a knowledge graph and/or stored in a graph database for subsequent evaluation of database queries indicating aliases of the tables and/or fields represented by nodes of the graph.

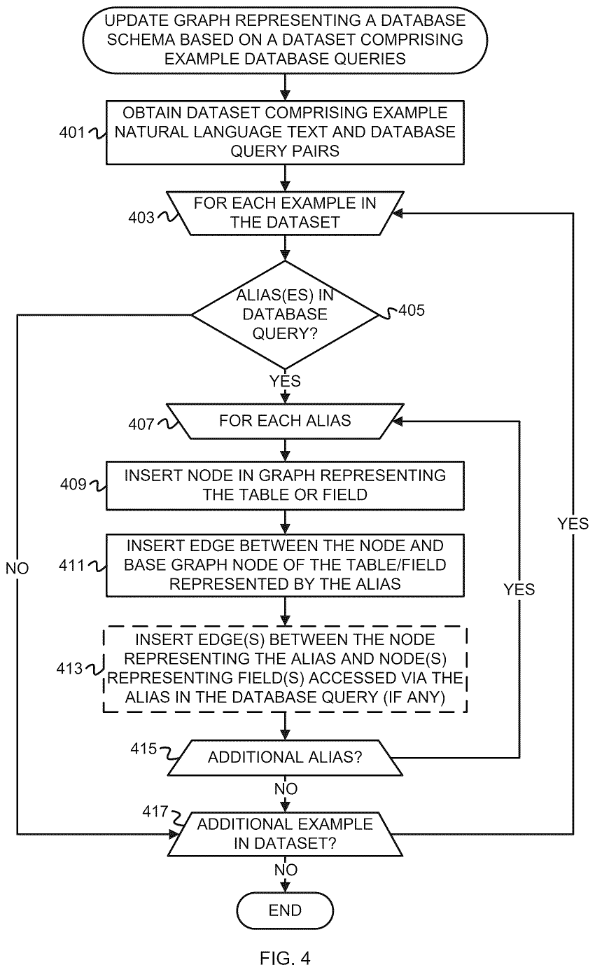

FIG. 4 is a flowchart of example operations for updating a graph representing a database schema based on a dataset comprising example database queries. The example operations assume that a graph representing the database's schema has been created to use as a “base graph” for evaluating database queries.

At block 401, the conflict detector obtains a dataset comprising example pairs of natural language text and database queries. The dataset comprises a plurality of pairs of example user queries comprising natural language text and corresponding database queries that are intended to be executable against the database to fulfill the user query. Each example may be labelled, tagged, or otherwise associated with an identifier.

At block 403, the conflict detector iterates over examples in the dataset. The conflict detector identifies the database query in each example.

At block 405, the conflict detector determines if the database query comprises one or more aliases. The conflict detector can evaluate syntax of the database query to determine if it comprises an alias(es) based on whether it comprises a keyword used for aliasing, such as by searching for an “as” keyword in the case of SQL queries. If the database query comprises an alias(es), operations continue at block 407. If not, operations continue at block 417.

At block 407, the conflict detector iterates over each alias identified in the database query. Database queries can include multiple aliases, and each alias represents a table or field.

At block 409, the conflict detector inserts a node in the graph representing the table or field represented by the alias. The conflict detector determines the table or field represented by the alias based on syntax of the database query and extracts (e.g., copies) the table or field name from the database query. The conflict detector adds a node to the graph that indicates the table or field name.

At block 411, the conflict detector inserts an edge between the node and the node of the base graph corresponding to the actual table or field name represented by the alias. The conflict detector adds an edge to the graph that connects the new node representing the alias with the node of the base graph representing the aliased table or field. The edge may be a directed edge. The conflict detector can add a property name, label, metadata, etc. to the edge added to the graph indicating that an aliasing relationship between the connected nodes exists.

At block 413, the conflict detector inserts an edge between the node representing the alias and a node(s) representing a field(s) accessed via the alias in the database query, if any. Block 413 is depicted with dashed lines to indicate that the conflict detector performs this operation for certain aliases, or aliases that correspond to a table and that are used to access a field(s) of that table. The conflict detector can determine that a field(s) is accessed via an alias based on syntax of the database query, such as to determine if the database query comprises dot notation that indicates the alias. For such cases, the conflict detector connects the node representing the alias to the node(s) of the base graph corresponding to the field accessed through the alias via a respective edge(s). The conflict detector can add a property name, label, metadata, etc. to the edge added to the graph indicating that a table-value relationship between the connected nodes exists.

At block 415, the conflict detector determines if the database query comprises an additional alias. If so, operations continue at block 407. Otherwise, operations continue at block 417.

At block 417, the conflict detector determines if there is an additional example in the dataset. If so, operations continue at block 403. Otherwise, operations are complete.

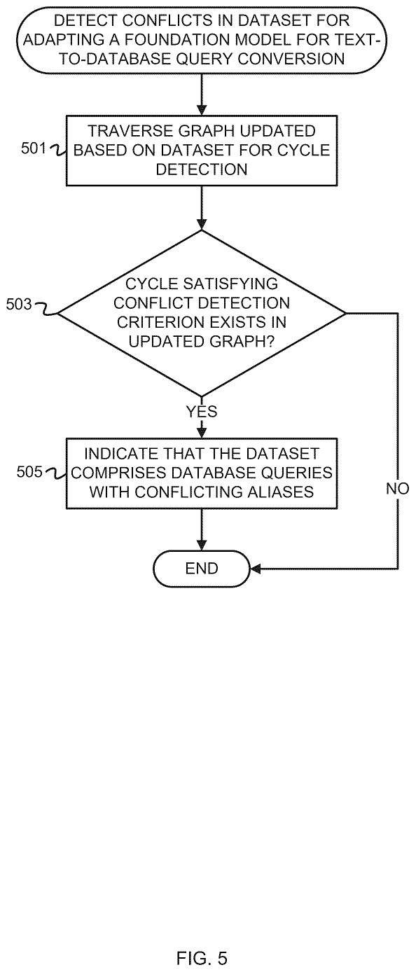

FIG. 5 is a flowchart for detecting conflicts in a dataset for adapting a foundation model for text-to-database query conversion. The example operations assume that a graph representing a database schema has been updated based on the dataset.

At block 501, the conflict detector traverses the graph that has been updated based on the dataset for cycle detection. The conflict detector performs a graph analysis on the updated graph or submits a query indicating a graph analysis to a graph database in which the updated graph is stored to determine if the graph comprises any cycles. For instance, the conflict detector can perform or submit a query to the graph database query to perform a DFS or union-find. A result of traversing the graph indicates whether the graph comprises any cycles and, for each cycle, the nodes that belong to the cycle.

At block 503, the conflict detector determines whether a cycle satisfying a conflict detection criterion exists in the updated graph. The conflict detector evaluates the results of traversing the graph based on the conflict detection criterion. The conflict detection criterion can indicate that a conflict between aliases exists if a cycle comprising multiple nodes that correspond to different aliases referring to the same table or field but that are not directly connected with an edge is identified in the updated graph. For instance, if the result of traversing the graph indicate a cycle that comprises two or more nodes representing aliases that correspond to the same table or field, the conflict detector can query the updated graph to determine if those nodes are connected themselves via an edge. If the conflict detection criterion is satisfied, then a cycle indicating that a conflict between aliases can be determined to be present in the updated graph. If a cycle satisfying the detection criterion exists, operations continue at block 505. Otherwise, operations are completed, and the dataset is presumed to have no conflicting aliases.

At block 505, the conflict detector indicates that the dataset comprises database queries with conflicting aliases. The conflict detector determines the database queries corresponding to the conflicting aliases based on a label, metadata, or other association of identifiers of examples in the dataset with the nodes identified in the cycle(s). The conflict detector can generate a notification or report indicating the alias conflict and affected database queries, store the notification or report (e.g., in a database or file), etc. The conflict detector can then delete the nodes of the graph representing the conflicting aliases so the database queries can be evaluated using the graph to verify that the conflict between aliases has been resolved.

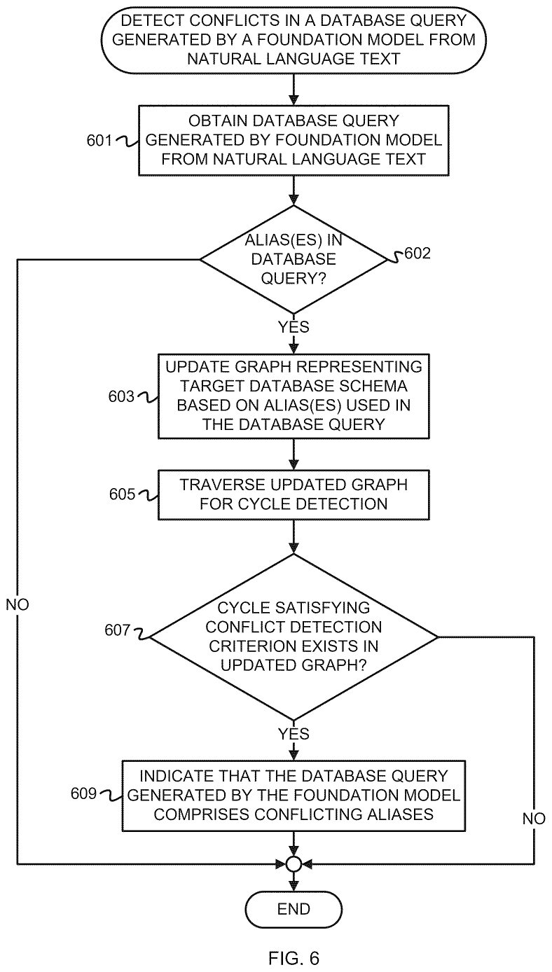

FIG. 6 is a flowchart of example operations for detecting conflicts in a database query generated by a foundation model from natural language text. The example operations assume that a graph representing the database's schema has been created to use as a “base graph” for evaluating database queries.

At block 601, the conflict detector obtains a database query generated by a foundation model from natural language text. The foundation model generated the database query based on receiving a prompt comprising the natural language text. The database query is written in a database query language used by a target database, such as a SQL query.

At block 602, the conflict detector determines if the database query comprises one or more aliases. The conflict detector determines if the database query comprises an alias(es) based on syntax of the database query, such as based on the presence of a keyword used for assigning aliases (e.g., the “as” keyword in SQL). If the database query comprises an alias(es), operations continue at block 603. If not, operations are complete.

At block 603, the conflict detector updates the graph representing the target database schema based on the one or more aliases used in the database query. The conflict detector updates the graph with a node representing each alias and one or more edges to connect the new node to at least the node of the graph representing the aliased table/field. If the node represents an alias of a table and one or more fields of that table is accessed via the alias, the conflict detector also inserts an edge between the node representing the alias and the node(s) representing those field(s).

At block 605, the conflict detector traverses the updated graph for cycle detection. The conflict detector traverses the graph according to one or more graph algorithms and/or analyses according to which cycles can be detected.

At block 607, the conflict detector determines if a cycle satisfying a conflict detection criterion exists in the updated graph. As described above, the conflict detector determines if the updated graph comprises a cycle that includes nodes representing aliases that do not have an edge therebetween indicating that an alias relationship exists between the aliases themselves. If the updated graph comprises a cycle satisfying the criterion, operations continue at block 609. Otherwise, operations are complete, and the database query can be executed against the target database.

At block 609, the conflict detector indicates that the database query generated by the foundation model comprises conflicting aliases. The conflict detector can indicate that the database query should not be executed since an error will result due to the conflicting aliases. For instance, the conflict detector can generate a notification indicating the conflicting aliases in the database query.

### Variations

The Figures and description refer to SQL queries in illustrative examples. Implementations are applicable to other database query languages and are not necessarily limited to database query languages used for relational databases.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

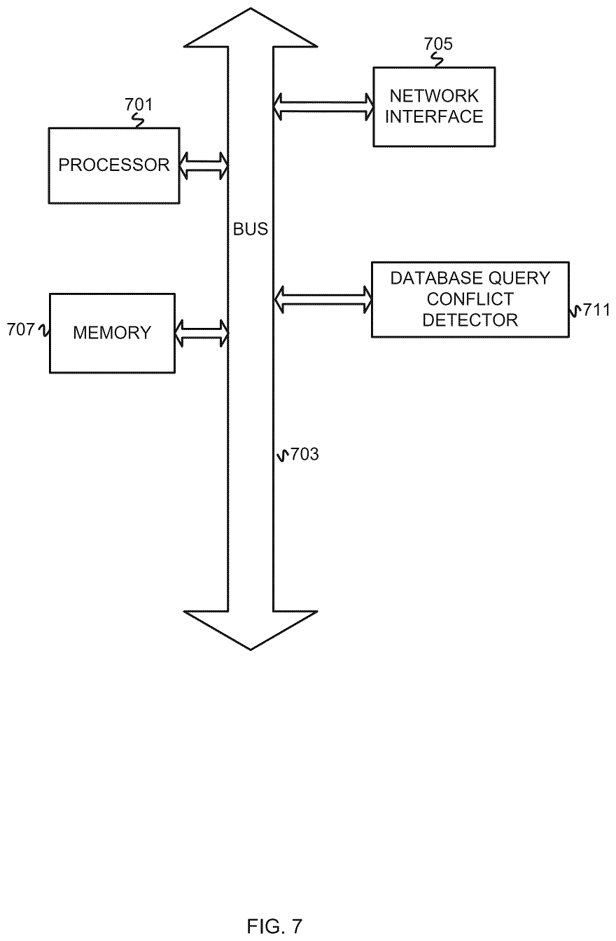

FIG. 7 depicts an example computer system with a database query conflict detector. The computer system includes a processor 701 (possibly including multiple processors, multiple cores, multiple nodes, and/or implementing multi-threading, etc.). The computer system includes memory 707. The memory 707 may be system memory or any one or more of the above already described possible realizations of machine-readable media. The computer system also includes a bus 703 and a network interface 705. The system also includes a database query conflict detector 711. The database query conflict detector 711 builds a graph representing a database schema and evaluates one or more database queries intended to be executable against the database for the presence of conflicting aliases. The database query conflict detector 711 adds nodes to the graph representing the database schema for each alias identified in a graph database and connects each added node(s) representing an alias to the node of the graph corresponding to the aliased table or field. The database query conflict detector 711 evaluates the graph updated based on the database query(ies) for the presence of cycles comprising nodes representing different aliases for the same table or field that do not have an alias relationship themselves and thus are indicative of a conflict between the aliases. Any one of the previously described functionalities may be partially (or entirely) implemented in hardware and/or on the processor 701. For example, the functionality may be implemented with an application specific integrated circuit, in logic implemented in the processor 701, in a co-processor on a peripheral device or card, etc. Further, realizations may include fewer or additional components not illustrated in FIG. 7 (e.g., video cards, audio cards, additional network interfaces, peripheral devices, etc.). The processor 701 and the network interface 705 are coupled to the bus 703. Although illustrated as being coupled to the bus 703, the memory 707 may be coupled to the processor 701.

1. A method comprising:
building a graph representing a schema of a target database, wherein the graph comprises a first plurality of nodes representing a plurality of tables of the target database, a second plurality of nodes representing a plurality of fields of respective ones of the plurality of tables of the target database, and a plurality of edges between respective ones of the first and second pluralities of nodes indicating relationships among the plurality of tables and the plurality of fields;
validating one or more database queries written in a database query language used by the target database based on the graph, wherein validating the one or more database queries comprises,
for each database query of the one or more database queries, based on determining that the database query indicates an alias of at least one of a first table of the plurality of tables and a first field of the plurality of fields, updating the graph with a first node representing the alias of the at least one of the first table and the first field and a plurality of edges between the first node and others of the first and second pluralities of nodes determined based on syntax of the database query;
determining if the graph that has been updated comprises a cycle that satisfies a conflict detection criterion; and
based on determining that the graph comprises a cycle that satisfies the conflict detection criterion, indicating that the one or more database queries comprise conflicting aliases.

2. The method of claim 1, wherein updating the graph comprises creating an edge between the first node and one of the first plurality of nodes that corresponds to the at least one of the first table and the first field.

3. The method of claim 2, further comprising, based on determining that the syntax of the database query indicates one or more fields of the first table and that the alias corresponds to the first table, creating one or more edges between the first node and one or more of the second plurality of nodes that correspond to the one or more fields.

4. The method of claim 1, wherein determining if the graph that has been updated comprises a cycle that satisfies the conflict detection criterion comprises determining if the graph comprises a cycle that includes at least two nodes that represent different aliases and are not directly connected with an edge.

5. The method of claim 1, wherein the one or more database queries comprise a plurality of database queries, wherein the plurality of database queries is included in training data for training a language model to convert natural language text to database queries in the database query language, and wherein validating the one or more database queries comprises validating the plurality of database queries in the training data.

6. The method of claim 5, wherein indicating that the plurality of database queries comprise conflicting aliases comprises indicating those of the plurality of database queries that comprise the conflicting aliases.

7. The method of claim 1, wherein the one or more database queries comprise a first database query generated by a language model, and wherein validating the one or more database queries comprises validating the first database query generated by the language model.

8. The method of claim 1, wherein building the graph comprises, for each table of the target database indicated in the schema,
creating a node corresponding to the table;
for each field of one or more fields of the table,
creating a node corresponding to the field; and
adding an edge between the node corresponding to the table and the node corresponding to the field.

9. The method of claim 1, wherein building the graph comprises storing the first plurality of nodes, the second plurality of nodes, and the plurality of edges in a graph database, and wherein updating the graph comprises updating the graph database.

10. One or more non-transitory machine-readable media having program code stored thereon, the program code comprising instructions to:
build a graph comprising a plurality of nodes and a plurality of edges based on a schema of a first database,
wherein a first subset of the plurality of nodes represents a plurality of tables of the first database indicated in the schema,
wherein a second subset of the plurality of nodes represents a plurality of fields of respective ones of the plurality of tables of the first database indicated in the schema,
and wherein the plurality of edges are between respective ones of the first and second subsets of nodes and indicate relationships among the plurality of tables and the plurality of fields; and
update the graph based on a plurality of database queries written in a database query language corresponding to the first database, wherein the instructions to update the graph comprise instructions to, for each database query of the plurality of database queries and for each corresponding alias determined to be indicated in the database query,
insert into the graph a node representing the alias, wherein the alias corresponds to a first table of the plurality of tables or a first field of the plurality of fields;
insert into the graph one or more edges between the node representing the alias and one or more others of the first and second subsets of nodes based on syntax of the database query;
determine whether the graph updated based on the plurality of database queries comprises a cycle that satisfies a first criterion; and
based on a determination that the graph comprises a cycle that satisfies the first criterion, indicate that one or more of the plurality of database queries comprise conflicting aliases.

11. The non-transitory machine-readable media of claim 10, wherein the instructions to determine whether the graph comprises a cycle that satisfies the first criterion comprise instructions to determine whether the graph comprises a cycle that includes at least two nodes that represent different aliases and are not directly connected with an edge.

12. The non-transitory machine-readable media of claim 10, wherein the instructions to insert one or more edges into the graph comprise instructions to,
create an edge between the node representing the alias and one of the plurality of nodes that corresponds to the first table or the first field; and
based on a determination that the syntax of the database query indicates one or more fields of the first table, create one or more edges between the node representing the alias and one or more of the second subset of nodes that correspond to the one or more fields, wherein the alias corresponds to the first table.

13. The non-transitory machine-readable media of claim 10, wherein the plurality of database queries is included in training data for training a language model to convert natural language text to database queries in the database query language, and wherein the instructions to update the graph comprise instructions to update the graph based on the plurality of database queries in the training data.

14. The non-transitory machine-readable media of claim 10, wherein the instructions to build the graph comprise instructions to, for each table of the first database indicated in the schema,
create a node corresponding to the table;
for each field of one or more fields of the table,
create a node corresponding to the field; and
create an edge between the node corresponding to the table and the node corresponding to the field.

15. An apparatus comprising:
a processor; and
a machine-readable medium having instructions stored thereon that are executable by the processor to cause the apparatus to,
build a graph comprising a plurality of nodes and a plurality of edges based on a schema of a first database,
wherein a first subset of the plurality of nodes represent a plurality of tables of the first database indicated in the schema,
wherein a second subset of the plurality of nodes represent a plurality of fields of respective ones of the plurality of tables indicated in the schema, and wherein edges in the plurality of edges are between respective ones of the first and second subsets of nodes and indicate relationships among the plurality of tables and the plurality of fields; and
validate one or more database queries written in a database query language used by the first database based on the graph, wherein the instructions to validate the one or more database queries comprise instructions to, for each database query of the one or more database queries, based on a determination that the database query indicates an alias of at least one of a first table of the plurality of tables and a first field of the plurality of fields, update the graph with a first node representing the alias of the at least one of the first table and the first field and a plurality of edges between the first node and others of the first and second pluralities of nodes determined based on syntax of the database query;
determine if the graph that has been updated comprises a cycle indicative of a conflict between aliases; and
based on a determination that the graph comprises a cycle indicative of a conflict between aliases, indicate that the one or more database queries comprise conflicting aliases.

16. The apparatus of claim 15, wherein the instructions executable by the processor to cause the apparatus to determine if the graph comprises a cycle indicative of a conflict between aliases comprise instructions executable by the processor to cause the apparatus to determine if the graph comprises a cycle that includes at least two nodes that represent different aliases and are not directly connected with an edge.

17. The apparatus of claim 15, wherein the instructions executable by the processor to cause the apparatus to update the graph comprise instructions executable by the processor to cause the apparatus to,
create an edge between the first node and one of the plurality of nodes that corresponds to the at least one of the first table and the first field; and
based on a determination that the syntax of the database query indicates one or more fields of the first table and that the alias corresponds to the first table, create one or more edges between the first node and one or more of the second subset of nodes that correspond to the one or more fields.

18. The apparatus of claim 15, wherein the one or more database queries comprise a plurality of database queries, wherein the plurality of database queries are included in training data for training a language model to convert natural language text to database queries in the database query language, and wherein the instructions executable by the processor to cause the apparatus to update the graph comprise instructions executable by the processor to cause the apparatus to update the graph based on the plurality of database queries in the training data.

19. The apparatus of claim 15, wherein the instructions executable by the processor to cause the apparatus to build the graph comprise instructions executable by the processor to cause the apparatus to, for each table of the first database indicated in the schema,
create a node corresponding to the table;
for each field of one or more fields of the table,
create a node corresponding to the field; and
add an edge between the node corresponding to the table and the node corresponding to the field.

20. The apparatus of claim 15, wherein the one or more database queries comprise a first database query generated by a language model, and wherein the instructions executable by the processor to cause the apparatus to validate the one or more database queries comprise instructions executable by the processor to cause the apparatus to validate the first database query generated by the language model.
